(19) United States
(12) Patent Application Publication
(10) Pub. No.: US 2011/0308544 A1
(43) Pub. Date: Dec. 22, 2011

(54) CLEANING METHOD OF PROCESSING CHAMBER OF MAGNETIC FILM, MANUFACTURING METHOD OF MAGNETIC DEVICE, AND SUBSTRATE TREATMENT APPARATUS

(75) Inventors: Tomoaki Osada, Tokyo (JP); Franck Ernult, Tokyo (JP)

(73) Assignee: CANON ANELVA CORPORATION, Kawasaki-shi (JP)

(21) Appl. No.: 13/069,635

(22) Filed: Mar. 23, 2011

Related U.S. Application Data
(63) Continuation of application No. PCT/JP2010/050704, filed on Jan. 21, 2010.

(30) Foreign Application Priority Data
Jan. 21, 2009 (JP) 2009-011443

(51) Int. Cl. B08B 7/00; C23F 1/08

(52) U.S. Cl. 134/1.1; 156/345.26

(57) ABSTRACT

The present invention provides a manufacturing method of a multilayer film, a manufacturing method of a magnetoresistance effect device, and a substrate treatment apparatus, capable of shortening the time of a cleaning step. In one embodiment of the present invention, the inside of an etching apparatus is cleaned by plasma of a mixed gas containing H₂ gas and O₂ gas between processes. This shortens the cleaning time to improve the productivity.

### CROSS-REFERENCES TO RELATED APPLICATIONS

This application is a continuation application of International Application No. PCT/JP2010/050704, filed Jan. 21, 2010, which claims the benefit of Japanese Patent Application No. 2009-011443, filed Jan. 21, 2009. The contents of the aforementioned applications are incorporated herein by reference in their entities.

### TECHNICAL FIELD

The present invention relates to a cleaning method of a processing chamber of a magnetic film, a manufacturing method of a magnetic device, and a substrate treatment apparatus which give a high productivity and are excellent in reliability.

### BACKGROUND ART

There is conventionally known a method of cleaning the inside of a treatment chamber by introducing a cleaning gas into a treatment chamber for dry etching or film-forming, and generating plasma in a state where no object to be treated is introduced, as shown in Patent Document 1. This removes and discharges the film material adhered inside the treatment chamber in dry etching or film-forming. Thus, it can be prevented that the adhered film material peels off in the treatment to cause particles or the generation state of plasma such as the distribution of plasma density varies at each time of treatment, which makes it possible to manufacture electronic parts having a high reliability.

[Patent Document 1] Japanese Patent Application Laid-open No. 8-330243

### SUMMARY OF INVENTION

However, in the manufacturing step of magnetic devices, magnetic materials adhere to an etching chamber when processing the magnetic devices into a prescribed shape. Patent Document 1 uses carbon tetrafluoride gas as a cleaning gas.

When cleaning treatment is performed using carbon tetrafluoride gas as described above, the cleaning step needs a long time to cause the lowering of productivity.

The present invention has been made in view of the above circumstances and a purpose thereof is to provide a cleaning method of a processing chamber of a magnetic film capable of shortening the time of a cleaning step, a manufacturing method of a magnetic device, and a substrate treatment apparatus.

In order to achieve such purposes, the present invention is a cleaning method of a processing chamber of a magnetic film, characterized by having a cleaning step of forming plasma of a cleaning gas containing oxygen and hydrogen as elements and removing a metal film constituting the magnetic film adhered to the inside of the chamber by the processing treatment of the magnetic film.

Moreover, the present invention is a manufacturing method of a magnetic device, characterized by having a cleaning step of forming plasma of a cleaning gas containing oxygen and hydrogen as elements in a treatment chamber in a state where a magnetic multilayer film is retracted from the treatment chamber between processing treatments for the magnetic multilayer film containing at least a magnetic layer, and then removing adhering materials to the treatment chamber produced by the processing treatment.

Furthermore, the present invention is a substrate treatment apparatus capable of performing a dry etching treatment, characterized by including a treatment chamber, a plasma-generating means for generating plasma in the treatment chamber, a gas-introducing means for introducing a cleaning gas containing oxygen and hydrogen as elements into the treatment chamber, and a control means for controlling the plasma-generating means and the gas-introducing means so as to introduce the cleaning gas into the treatment chamber and generate the plasma of the cleaning gas in the cleaning of the inside of the treatment chamber after the dry etching treatment.

According to the present invention, the cleaning of the etching chamber is possible in a short time, and the manufacturing of electronic parts such as a magnetoresistance device having a high productivity and reliability can be realized.

### BRIEF DESCRIPTION OF THE DRAWINGS

FIG. 1 is a schematic cross-sectional view showing an example of manufacturing steps of a

TMR device made of a magnetic multilayer film, according to an embodiment of the present invention.

FIG. 2 is a flow chart showing a manufacturing method of a magnetoresistance effect device including a cleaning step according to an embodiment of the present invention.

FIG. 3 is an outline cross-sectional view of an etching apparatus used for a dry etching treatment according to an embodiment of the present invention.

FIG. 4 is a graph showing a test result of Example of the present invention.

FIG. 5 is a graph showing a test result of Comparative Example 1 of the present invention.

FIG. 6 is a graph showing a test result of Comparative Example 2 of the present invention.

### DESCRIPTION OF EMBODIMENTS

Hereinafter, a manufacturing method of a magnetic device, such as a magnetoresistance device, of the present invention will be described while citing a case of manufacturing a TMR (Tunnel Magneto-Resistance) device as an example. The TMR device can be used for an MRAM (Magnetic Random Access Memory), a sensor of a magnetic head etc. Meanwhile, in the DESCRIPTION, “-” inserted between metal elements is an expression that does not specify the composition ratio.

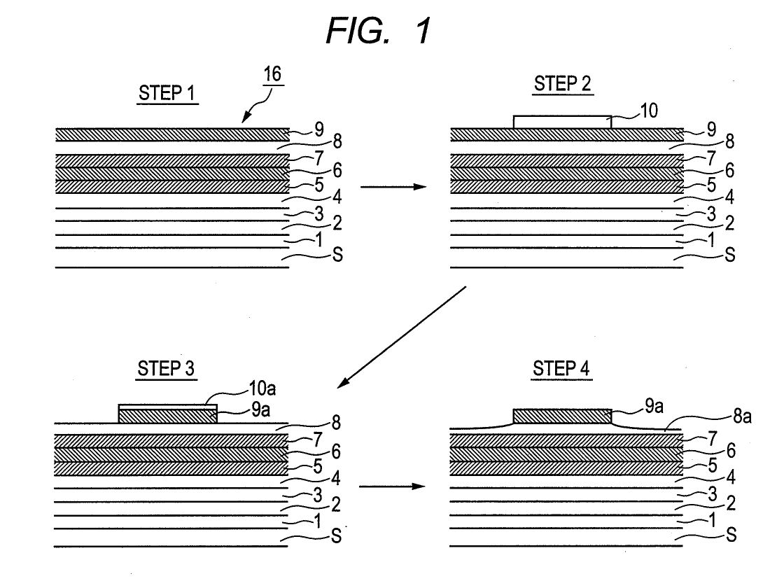

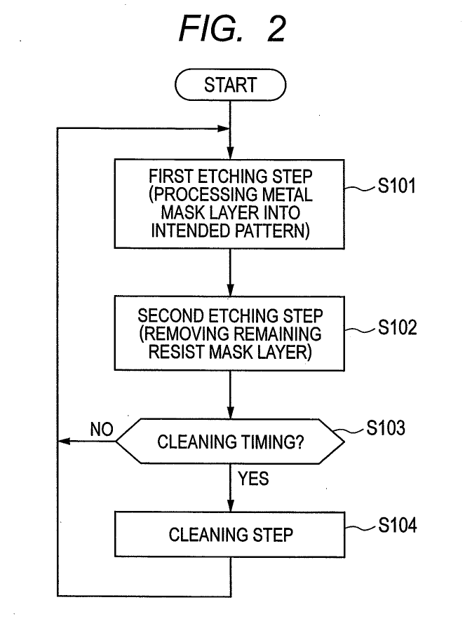

FIG. 1 is a schematic cross-sectional view showing an example of manufacturing step of a TMR device made of a magnetic multilayer film, according to an embodiment of the present invention, and FIG. 2 is a flow chart showing a manufacturing method of a magnetoresistance device including a cleaning step according to the embodiment of the present invention.

Firstly, in step 1 in FIG. 1, over a substrate S, a Ta film 1, an Al film 2 that is a lower electrode, a Ta film 3 that is a foundation layer, an antiferromagnetic layer 4 made of PtMn, a ferromagnetic pin layer 5 made of Co—Fe, an insulating layer 6 made of Al—O, and a ferromagnetic free layer 7 made of Co—Fe are laminated sequentially. Further, over the free layer 7, a Ni—Fe layer 8 that is a shielding layer and a Ta film 9 that is a metal mask layer are laminated. Thus, a multilayer film 16 as shown in step 1 in FIG. 1 is prepared. In the embodiment, all necessary films are laminated with a sputtering apparatus. Meanwhile, they may be formed by another method such as a CVD (Chemical Vapor Deposition) method, instead of the sputtering method.

Moreover, a film structure, too, is not limited to the one shown in FIG. 1, but one including an MTJ (Magnetic Tunnel Junction) part including at least the insulating layer 6 and the ferromagnetic layers (pin layer 5 and free layer 7) formed on both sides of the insulating layer 6 is acceptable. Specifically, for example, the pin layer 5 may be a layer having plural layers, for example, a pinned layer, and a spacer and reference layers (for example, CoFe/Ru/CoFe), etc. Moreover, the insulating layer 6 is not limited to one formed from alumina, but it may be one formed from magnesium oxide or one formed by adding another element to magnesium oxide. That is, in the present invention, the structure itself of the MTJ part is not essential, and, therefore, specific structure and materials thereof may be any.

Next, in the step 2 in FIG. 1, a metal mask layer is formed over the multilayer film prepared in the step 1, and a first etching step of processing the metal mask layer into an intended pattern is performed. Firstly, a resist mask layer 10 for processing the magnetic multilayer film into an intended pattern is formed over the Ta film 9, and the resist mask layer 10 formed over the Ta layer 9 is formed into an intended pattern by exposure and development. After that, in the step 3 in FIG. 1, the Ta film 9 is processed into an intended pattern by a dry etching treatment using the resist mask layer 10 as a mask (step S101 in FIG. 2: first etching step). In the first etching step, as an etching gas, a gas having a higher etching rate for the Ta film 9 than for the resist mask layer 10 is used. For example, as the etching gas used in the first etching step, a halogen-containing gas such as carbon tetrafluoride gas (CF₄ gas) is used.

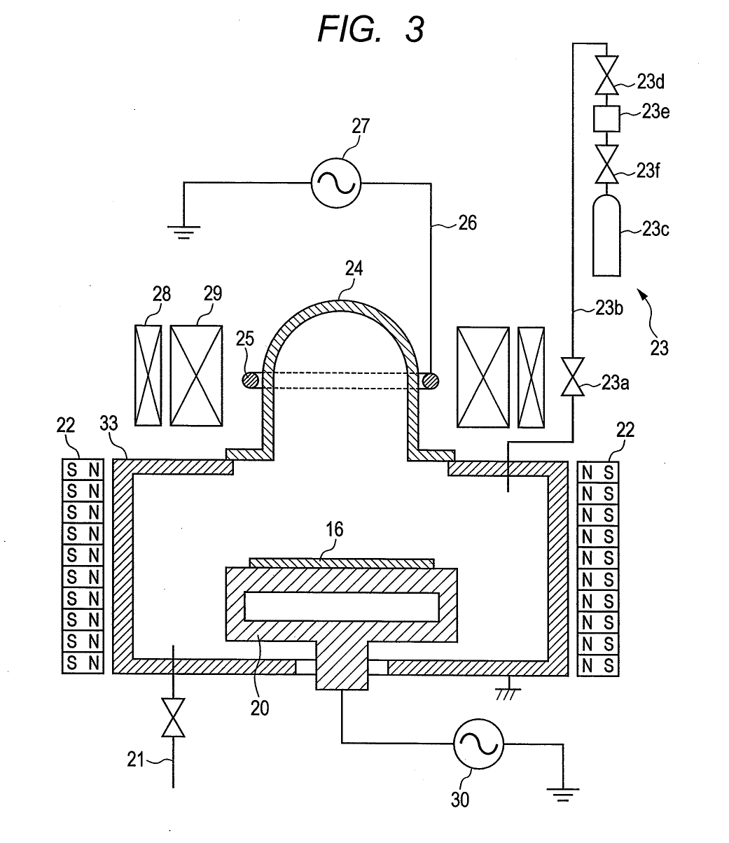

Here, the first etching step (step 3 in FIG. 1, and step S101 in FIG. 2) will be described specifically, using the outline cross-sectional view of an etching apparatus mounted with an ICP (Inductive Coupled Plasma) plasma source, which can be used in the first etching step, as a processing chamber of a magnetic film, shown in FIG. 3.

The inside of a vacuum vessel 33 is evacuated by an evacuating system 21, a gate valve (not shown) is opened and the multilayer film 16 having a laminated structure formed in the step 2 in FIG. 1 is carried in the vacuum vessel 33, held by a substrate holder 20 and maintained at an intended temperature by a temperature control mechanism 32.

Next, a gas introduction system 23 is operated, and an etching gas (CF₄) having an intended flow rate is introduced into the vacuum vessel 33 from a steel cylinder 23c storing gasses including CF₄ gas as an etching gas according to the first etching step via a pipe 23b, valves 23a, 23d and 23f, and a flow controller 23e. The introduced etching gas diffuses into a dielectric wall vessel 24 via the inside of the vacuum vessel 33. At this time, plasma is generated in the vacuum vessel 33. Moreover, the evacuating system 21 is also operated.

A mechanism for generating the plasma has the dielectric wall vessel 24, an antenna 25 of one turn for generating an induced magnetic field in the dielectric wall vessel 24, a high frequency power source 27 for plasma, and electromagnets 28 and 29 for holding an intended magnetic field in the dielectric wall vessel 24, etc. The dielectric vessel 24 is connected air-tightly to the vacuum vessel 33 so that the inner space is communicated, and the high frequency power source 27 for plasma is connected to the antenna 25 by a transmission path 26 via a matching box (not shown).

In the above-described structure, when a high frequency wave generated by the high frequency power source 27 for plasma is supplied to the antenna 25 through the transmission path 26, current flows to the antenna 25 of one turn, and, as the result, plasma is formed inside the dielectric wall vessel 24.

Meanwhile, outside the sidewall of the vacuum vessel 33, many magnets 22 for the sidewall are disposed side by side in the circumference direction so that a magnetic pole on a side of a magnet facing the sidewall of the vacuum vessel 33 is different from that of a magnet adjacent to the magnet. Consequently, cusped magnetic fields are formed continuously in the circumference direction along the inner surface of the sidewall of the vacuum vessel 33, to prevent or lower the diffusion of the plasma into the inner surface of the sidewall of the vacuum vessel 33.

On this occasion, at the same time, a high frequency power source 30 for bias is operated, and a bias voltage that is a voltage corresponding to minus direct current is applied to the multilayer film 16 that is an object for an etching treatment, to control an ion injection energy to the surface of the substrate 16 from the plasma. The plasma formed as described above diffuses into the vacuum vessel 33 from the dielectric wall vessel 24, reaches the vicinity of the surface of the multilayer film 16 and reacts with the surface of the multilayer film 16.

At this time, ions and radicals of fluorine in the plasma of the etching gas are bonded with Ta in the Ta film 9 to form TaF_{X} (X is a positive number), which is vaporized and evacuated. On the other hand, carbon and hydrogen in the resist mask layer 10 made of an organic compound also react with ions and radicals of fluorine, and ions and radicals of carbon in the plasma to form molecules such as CF₄, HF and C₂H₄, which are evaporated and evacuated. However, CF₄ is in an equilibrium relation with the etching gas and thus has a low generation rate, and carbon forms polymer at the surface of the resist mask layer 10, and, therefore, TaF_{X} is generated more easily. As the result, the Ta film 9 is removed preferentially, and is processed into the pattern of the resist mask layer 10, and a part of the resist mask layer 10 remains over the surface of a Ta film 9a [step 3 in FIG. 1]. By such first etching step, in a state where a resist mask layer 10a is formed over the Ta film 9a patterned into an intended pattern, the Ni—Fe layer 8 being a lower layer of the Ta film 9a is consequently exposed in a region in which the Ta film 9a is not formed.

Meanwhile, although not shown, the etching apparatus in FIG. 3 includes a controller for controlling respective constituent elements such as the evacuating system 21, the temperature control mechanism 32, the gas introduction system 23 and the high frequency power source 27 for plasma, and the controller is configured so that it can continuously perform intended etching operations (for example, first etching step, second etching step, etc.) according to a predetermined program. Furthermore, the controller may perform a cleaning treatment, too, according to a predetermined program, in addition to the above-described etching operation.

Next, in the second etching step, the resist mask layer 10a remaining over the surface of the Ta film 9a patterned into an intended pattern is removed (step S102 in FIG. 2). In the present embodiment, a second etching step is performed continuously by performing the evacuation in a state where the multilayer film 16 is placed as it is after the end of the dry etching in the first etching step, and introducing an etching gas switched to the etching gas for the second etching step. In the second etching step, a gas having a higher etching rate for the resist mask layer 10a than for the Ta film 9 and the exposed Ni—Fe layer 8 is used as the etching gas, and, specifically, for example, oxygen gas is used.

That is, the steel cylinder 23c is switched to a steel cylinder storing oxygen gas as an etching gas for removing the resist mask layer 10a, and a controller (not shown) controls the evacuating system 21 to practice the evacuation of the vacuum vessel 33, and controls the gas introduction system 23 to introduce oxygen gas as the etching gas in the second etching step into the vacuum vessel 33. By introducing oxygen gas as the etching gas containing oxygen as the element, the dry etching treatment is performed on the multilayer film 16, at least a part of which is exposed by the resist mask layer 10a, to remove the resist mask layer 10a.

By generating plasma as described above after introducing the gas for the second etching step, the resist mask layer 10a remaining over the Ta film 9a reacts with ions and radicals of oxygen in the plasma, and the resist mask layer 10a is evaporated as CO_{X} etc. and removed [step 4 in FIG. 1]. At this time, the exposed surface of the Ni—Fe layer 8 is also physically etched by the collision with ions in the plasma to form a state in which a part thereof is removed. At this time, the controller controls the evacuating system 21 to evacuate the inside of the vacuum vessel 33. Then, a part of the material of the etched Ni—Fe layer 8 becomes particulate and is evacuated, but another part adheres to the inner wall of the vacuum vessel 33 and remains in the vacuum vessel 33.

As described above, in the present embodiment, an organic compound is used as the resist mask layer 10a and oxygen gas is used as the etching gas for removing the resist mask layer 10a. Therefore, materials removed by the etching gas (oxygen gas) in the second etching step (step of removing resist mask layer) are evaporated and evacuated, and do not adhere to the inside of the vacuum vessel 33. That is, in the present embodiment, as the result of using an organic compound as the resist mask layer 10a and using oxygen gas as the etching gas, it is possible to prevent the resist mask layer 10a to be removed from being a generation source of adhering material which is the object to be removed by the cleaning.

After that, the multilayer film 16 is carried out from the vacuum vessel 33 and subjected to the subsequent step. Here, when a prescribed cleaning timing has not been reached yet (step S103: NO), in the etching apparatus, the next substrate over which the resist mask layer 10 has been formed as shown in FIG. 1(b) is carried in, and the above-described first and second etching steps are performed again. On the other hand, when a prescribed cleaning timing is reached (step S103: YES), the controller performs the cleaning step in a state where no multilayer film 16 is introduced into the vacuum vessel 33 (step S104). The cleaning timing can be set arbitrarily, and the cleaning is performed, for example, after every several ten times of dry etching treatments.

In the cleaning step of the inside of the vacuum vessel 33 at step S104, the cleaning is performed by introducing a cleaning gas containing hydrogen gas and oxygen gas into the vacuum vessel 33, and operating the high frequency power source 27 for plasma to generate a plasma. That is, the steel cylinder 23c is switched to a steel cylinder storing a cleaning gas containing oxygen and hydrogen as elements for the cleaning, and the controller controls the gas introduction system 23 to introduce the cleaning gas into the vacuum vessel 33 and controls the high frequency power source 27 for plasma to form plasma of the cleaning gas in the vacuum vessel 33. By the plasma of the cleaning gas thus generated, depositions adhered to the inside of the vacuum vessel 33 and dielectric vessel 24 are removed.

At this time, the operation of the high frequency power source 30 for bias is not essential, but, by operating the high frequency power source 30 for bias, the substrate holder 20 can be cleaned at a higher rate. Meanwhile, although the multilayer film 16 is not introduced in the present embodiment, by performing the cleaning in a state where a substrate S over which no film is formed (dummy substrate) is introduced, the damage of the substrate holder 20 can be reduced. Needless to say, the cleaning may be performed without the dummy substrate.

The cleaning gas is not limited to a mixed gas of hydrogen gas and oxygen gas only if it contains oxygen and hydrogen as elements, but it may additionally contain an inert gas etc. For example, O₃, H₂O (water) etc. may be used. Meanwhile, a gas of alcohol etc. may also be used, but, since carbon easily adheres to the chamber wall etc. and might cause particles, the use of gases containing no carbon is preferable. Moreover, the flow rate ratio is also not particularly limited, but, in order to generate a hydroxide, the ratio of O and H in the cleaning gas is preferably in the range of around 3:7 to 7:3. A too large content of O might lead to an oxide that can not be evacuated as vapor. As the result of the generation of the cleaning gas plasma, the Ni—Fe layer 8 is vaporized as NiOH, Fe(OH)_{X} etc. and is evacuated. Other magnetic materials (for example, Co, Fe, Ni, and alloys thereof, and those formed by adding such an element as B or C) may also be removed as a hydroxide in the same manner.

The evacuation after the plasma generation makes it possible to perform the first etching step in a state where the next multilayer film 16 is introduced. Meanwhile, in one cleaning step, the plasma generation of the cleaning gas and the evacuation may be repeatedly performed multiple times.

The use of a gas containing oxygen and hydrogen as elements as the cleaning gas, as described above, can shorten the time necessary for the cleaning step and improve the productivity of magnetoresistance devices.

Meanwhile, in the above embodiment, the case of the TMR device is explained, but the present invention can also be applied to the manufacturing of GMR devices using a nonmagnetic electroconductive layer such as Cu in place of the insulating layer 6.

Meanwhile, in the present invention, the cleaning after removing the resist mask layer in the manufacturing of magnetoresistance effect devices is explained, but the cleaning of the present invention can be applied to other devices. It is important in the present invention to clean (remove) in a short time adhering materials (for example, Ni—Fe etched from the Ni—Fe layer 8 in FIG. 1) that are generated in the etching step for removing the resist mask layer (second etching step in FIG. 2) and adhered to the inside of the vacuum vessel as a treatment chamber, after removing a resist mask layer for processing a prescribed layer (for example, Ta film 9 in FIG. 1) into an intended pattern. Therefore, it is the essence of the present invention to perform the cleaning using a cleaning gas containing oxygen and hydrogen as elements (the cleaning gas according to the present invention), instead of carbon tetrafluoride gas in conventional manners. Accordingly, devices to be a manufacturing object are not limited to the above-described magnetoresistance device, but they may be GMR (Giant Magneto-Resistance) devices, vertical magnetic recording media etc., if they have a multilayer film as an object for which an intended pattern is to be formed by the resist mask layer.

However, the plasma of the cleaning gas according to the present invention needs to remove adhering materials in the vacuum vessel generated in the etching step for removing the resist mask layer (for example, second etching step). Depending on an embodiment of the present invention, the adhering materials may be materials generated by etching the above-described exposed layer, or may be materials generated by etching the resist mask layer, in the second etching step. Alternatively, the adhering materials may be both of them. Accordingly, in the present invention, adhering materials adhered to the vacuum vessel after being generated from at least one of the resist mask layer and the exposed layer by the etching step for removing the resist mask layer are those that are vaporized by the plasma of the cleaning gas according to the present invention. From the opposite standpoint, adhering materials generated in the etching step for removing the resist mask layer are generated from at least one of the resist mask layer and the exposed layer by the dry etching treatment, and, therefore, in the resist mask layer and the exposed layer, the raw material of the layer that is lead to be the adhering material by adhering to the inside of the vacuum vessel by the etching treatment is such a material that the adhering material is vaporized by the plasma of the cleaning gas according to the present invention.

For example, when an organic compound is used as the resist mask layer and oxygen gas is used as the etching gas for the second etching step, as is the case for the aforementioned embodiment, the layer exposed in the etching treatment for removing the resist mask layer (for example, Ni—Fe layer 8 in step 3 in FIG. 1) needs to be made of such a material that is evaporated by the plasma of the cleaning gas according to the present invention.

### EXAMPLE

Next, tests performed for checking the effect of the present invention will be explained.

In the tests, the etching apparatus shown in FIG. 3 was used, and, after performing the second etching step by predetermined times, the cleaning step was performed. Conditions of the cleaning step in Example and Comparative Examples 1 and 2 are as shown below.

### Example

Cleaning time (discharge time after gas introduction): 180 sec

Flow rate of O₂ gas/Flow rate of H₂ gas: 70 sccm/30 sccm

Power for plasma/Power for bias (power of high frequency power source 27 for plasma/power of high frequency power source 30 for bias): 2500 W/200 W

Pressure in vacuum vessel 33: 0.7 Pa

### Comparative Example 1

Flow rate of O₂ gas: 100 sccm

Other conditions are the same as those in Example.

### Comparative Example 2

Flow rate of O₂ gas/Flow rate of CF₄ gas: 70 sccm/30 sccm

Other conditions are the same as those in Example.

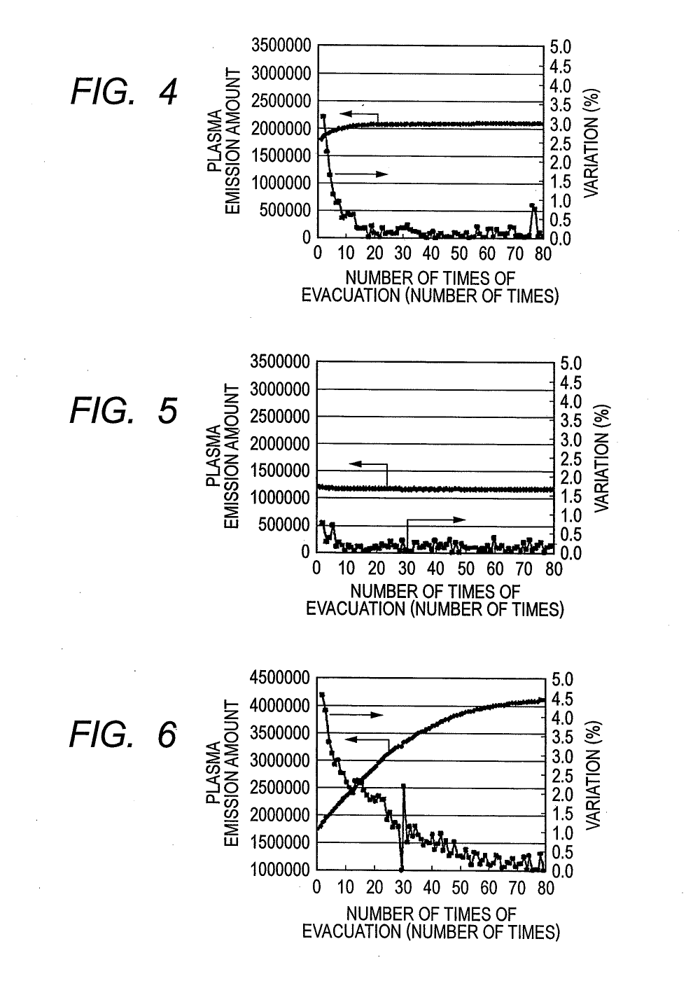

FIGS. 4 to 6 show test results. In graphs in FIGS. 4 to 6, the transverse axis denotes the number of times of cleaning, that is, shows the number of repeating times of the step of discharging for the above-described cleaning time and evacuating, after introducing the cleaning gas. The left longitudinal axis means the measured value of the plasma emission amount of the cleaning gas in the vacuum vessel 33, and the right longitudinal axis is the variation (%) thereof for every sheet.

In Example, it is known that the variation of the plasma emission amount is stabilized at the 16th time to show that the cleaning has been completed. In Comparative Example 1, little variation of the plasma emission exists during the practice of the cleaning, and it can be estimated that the effect of the cleaning is small. In Comparative Example 2, many times of the cleaning are required until the variation of the plasma emission is stabilized, and thus the cleaning is not effective.

Hence, it is known that Example is effective as the cleaning step.

1. A cleaning method of a processing chamber of a magnetic film comprising a cleaning step of forming plasma of a cleaning gas containing oxygen and hydrogen as elements, and removing a metal film constituting the magnetic film adhered to the inside of the chamber by a processing treatment of the magnetic film.

2. A cleaning method of a processing chamber of a magnetic film according to claim 1, wherein
the cleaning gas contains hydrogen gas and oxygen gas.

3. A manufacturing method of a magnetic device comprising a cleaning step of forming plasma of a cleaning gas containing oxygen and hydrogen as elements in a treatment chamber in a state where a magnetic multilayer film is removed from the treatment chamber between processing treatments for the magnetic multilayer film containing at least a magnetic layer, and then removing adhering materials to the treatment chamber produced by the processing treatment.

4. A manufacturing method of a magnetic device according to claim 3, wherein
the cleaning gas contains hydrogen gas and oxygen gas.

5. A substrate treatment apparatus capable of performing a dry etching treatment, the apparatus comprising:
a treatment chamber;
a plasma-generating means for generating plasma in the treatment chamber;
a gas-introducing means for introducing a cleaning gas containing oxygen and hydrogen as elements in the treatment chamber; and
a control means for controlling the plasma-generating means and the gas-introducing means so as to introduce the cleaning gas into the treatment chamber and generate the plasma of the cleaning gas in the cleaning of the inside of the treatment chamber after the dry etching treatment.
